(19) United States
(12) Patent Application Publication
(10) Pub. No.: US 2026/0045881 A1
(43) Pub. Date: Feb. 12, 2026

(54) FLYBACK POWER CONVERTER WITH MULTIFUNCTIONAL PIN AND CONTROL CIRCUIT AND CONTROL METHOD THEREOF

(71) Applicant: Richtek Technology Corporation, Zhubei City (TW)

(72) Inventors: Li-Di Lo, Taichung (TW); Chien-Fu Tang, Hsinchu (TW); Tzu-Chen Lin, Hsinchu (TW); Shih-Ho Hsu, Hsinchu (TW)

(21) Appl. No.: 19/360,612

(22) Filed: Oct. 16, 2025

Related U.S. Application Data
(60) Provisional application No. 63/676,904, filed on Jul. 30, 2024.

(30) Foreign Application Priority Data
Jun. 16, 2025 (TW) 114122554

(51) Int. Cl. H02M 3/335; H02M 1/00

(52) U.S. Cl. CPC H02M 3/33523; H02M 1/0009

(57) ABSTRACT

A flyback converter includes: a transformer, including a primary, a secondary, and an auxiliary winding; a first switch, coupled to the transformer; a sensing resistor, for sensing a current through the first switch to generate a current sensing signal; an impedance element, coupled to the auxiliary winding; and a primary-side control circuit including a multifunctional pin, an auxiliary signal sensing circuit, and a current sensing circuit, and controlling the first switch to switch the primary winding. During an off-period, the auxiliary signal sensing circuit collaboratively generates an auxiliary current with the impedance element through the multifunctional pin, and receives the auxiliary current through the multifunctional pin to generate an auxiliary-related output signal. During an on-period, the current sensing circuit receives the current sensing signal through the multifunctional pin to generate a current-related output signal. The auxiliary current is positively correlated to an auxiliary voltage of the auxiliary winding.

### CROSS REFERENCE

The present invention claims priority to the TW patent application Ser. No. 114122554, filed on Jun. 16, 2025.

### BACKGROUND OF THE INVENTION

### Field of Invention

The present invention relates to a flyback converter, and more particularly to a flyback converter having a multifunctional pin. The present invention also relates to a control circuit and a control method for controlling the flyback converter.

### Description of Related Art

FIG. 1 illustrates a flyback converter of the prior art. In the architecture of the prior-art flyback converter, a primary-side control circuit typically performs control through dedicated pins. As shown in FIG. 1, during an on-period of a first switch M1, a current sensing signal Vcs is generated by sensing a current flowing through a sensing resistor Rcs, and is transmitted through a current sensing pin PCS to a primary-side control circuit 900, so as to perform current modulation and power control, thereby controlling energy delivered through a transformer 10 to an output terminal.

On the other hand, a resistor R4 and a resistor R5 coupled to an auxiliary winding NA form a voltage divider circuit, such that, during an off-period of the first switch M1, the primary-side control circuit 900 senses a valley point of a drain voltage of the first switch M1 through an auxiliary voltage sensing pin PDM, the valley point being correlated with an output voltage Vout. The primary-side control circuit 900 thereby performs functions such as zero voltage switching (ZVS) control, timing determination for turning on synchronous rectification, and output over-voltage protection (OVP).

In the prior art, the current sensing function and the auxiliary voltage sensing function are typically executed through two separately arranged pins, for example, separately providing a current sensing pin (e.g., PCS) and an auxiliary voltage sensing pin (e.g., PDM) to respectively transmit their sensing signals (e.g., the current sensing signal Vcs and an auxiliary voltage-related signal). Therefore, an IC (Integrated Circuit) integrating the primary-side control circuit requires more pins.

### SUMMARY OF THE INVENTION

From one perspective, the present invention provides a flyback converter, comprising: a transformer including a primary winding, a secondary winding, and an auxiliary winding, wherein the auxiliary winding is configured to generate an auxiliary voltage; a first switch coupled to the transformer; a sensing resistor coupled to the first switch at a sensing node and configured to sense a current flowing through the first switch to generate a current sensing signal; a first impedance element coupled to the auxiliary winding; and a primary-side control circuit configured to control the first switch to switch the primary winding, wherein the primary-side control circuit includes: a multifunctional pin coupled to the sensing node; an auxiliary signal sensing circuit configured, during an auxiliary signal sensing operation, to generate an auxiliary current collaboratively with the first impedance element through the multifunctional pin, and configured to receive the auxiliary current through the multifunctional pin to generate an auxiliary-related output signal; and a current sensing circuit configured, during a current sensing operation, to receive the current sensing signal through the multifunctional pin to generate a current-related output signal; wherein, during an on-period, the current sensing circuit is configured to perform the current sensing operation through the multifunctional pin, and during an off-period, the auxiliary signal sensing circuit is configured to perform the auxiliary signal sensing operation through the multifunctional pin; wherein the on-period corresponds to a conduction time of the first switch, and the off-period corresponds to a non-conduction time of the first switch; and wherein, during the off-period, the auxiliary current flowing through the multifunctional pin is positively correlated with the auxiliary voltage, and the auxiliary voltage is positively correlated with a voltage across the secondary winding.

In one embodiment, during the off-period, a voltage at the multifunctional pin is clamped to a clamp voltage, and the clamp voltage is independent of the auxiliary voltage.

In one embodiment, the auxiliary signal sensing circuit includes a current mirror circuit; wherein the auxiliary signal sensing operation includes: generating a mirrored current based on the auxiliary current by the current mirror circuit; and generating the auxiliary-related output signal based on the mirrored current by the auxiliary signal sensing circuit; wherein the auxiliary-related output signal corresponds to an analog output signal or a comparison output signal, the analog output signal being positively correlated with the auxiliary voltage, and the comparison output signal indicating a comparison result between the mirrored current and a current comparison threshold; wherein the auxiliary-related output signal is optionally configured to control the first switch.

In one embodiment, the auxiliary signal sensing circuit further includes a first current comparison circuit and/or a second current comparison circuit, the current comparison threshold including a first current comparison threshold and/or a second current comparison threshold; wherein the auxiliary signal sensing operation includes: comparing the mirrored current with the first current comparison threshold by the first current comparison circuit, and controlling the first switch to turn on through the comparison output signal when the mirrored current is lower than the first current comparison threshold, wherein the first current comparison threshold is associated with a valley voltage of the auxiliary voltage; and/or comparing the mirrored current with the second current comparison threshold by the second current comparison circuit, and controlling the first switch to turn off through the comparison output signal when the mirrored current is higher than the second current comparison threshold, wherein the second current comparison threshold is associated with an over-voltage threshold of the auxiliary voltage.

In one embodiment, when the first switch turns off to enter the off-period, the first current comparison circuit and/or the second current comparison circuit begins operation after a delay time.

In one embodiment, the current mirror circuit includes a first transistor and a second transistor, and the first impedance element includes a resistor; wherein the auxiliary signal sensing operation includes: generating the auxiliary current collaboratively with the resistor through the multifunctional pin and receiving the auxiliary current by a first terminal of the second transistor, thereby generating the mirrored current at a first terminal of the first transistor, and controlling the clamp voltage by the first terminal of the second transistor; wherein a second terminal of the first transistor and a second terminal of the second transistor are jointly coupled to a first reference voltage, and a control terminal of the first transistor and a control terminal of the second transistor are coupled together.

In one embodiment, the auxiliary signal sensing circuit further includes a first amplifier circuit; wherein the auxiliary signal sensing operation further includes: controlling the first transistor and the second transistor based on a voltage at the first terminal of the second transistor and a second reference voltage through feedback by the first amplifier circuit, such that the voltage at the first terminal of the second transistor is clamped to the clamp voltage, wherein the clamp voltage is associated with the second reference voltage.

In one embodiment, the control terminal of the second transistor is coupled to the first terminal of the second transistor to form a diode-connected transistor; wherein the auxiliary signal sensing operation further includes: controlling the control terminal of the second transistor based on a voltage at the first terminal of the second transistor through feedback, thereby clamping the voltage at the first terminal to the clamp voltage, wherein the clamp voltage is associated with a threshold voltage of the second transistor.

In one embodiment, the auxiliary signal sensing circuit further includes a second amplifier circuit; wherein the auxiliary signal sensing operation further includes: controlling a voltage at the first terminal of the first transistor to track a voltage at the first terminal of the second transistor through feedback by the second amplifier circuit, such that a first transistor current flowing through the first transistor is positively correlated with a second transistor current flowing through the second transistor; wherein the first transistor current corresponds to the mirrored current; wherein the first transistor and the second transistor operate in a saturation region, such that during the off-period, the voltage at the multifunctional pin is clamped to the clamp voltage and is independent of the auxiliary voltage.

In one embodiment, the auxiliary signal sensing circuit further includes a conversion resistor; wherein the auxiliary signal sensing operation further includes: generating the analog output signal based on the mirrored current by the conversion resistor.

In one embodiment, the first transistor and the second transistor operate in a saturation region such that the clamp voltage is not linearly related to the auxiliary voltage.

In one embodiment, the current sensing circuit includes a current sensing comparator; wherein the current sensing operation includes: comparing the current sensing signal with a current sensing threshold to generate the current-related output signal by the current sensing comparator, wherein the current-related output signal controls the first switch to turn off when the current sensing signal exceeds the current sensing threshold.

In one embodiment, the flyback converter further comprises: a second impedance element coupled between the sensing node and the multifunctional pin, and configured to isolate the auxiliary current during the auxiliary signal sensing operation, such that the auxiliary current flows through the multifunctional pin into the auxiliary signal sensing circuit.

In one embodiment, an impedance value of the second impedance element is greater than an impedance value of the sensing resistor for at least 100 times.

From another perspective, the present invention provides a primary-side control circuit configured to control a first switch of a flyback converter to switch a primary winding, the flyback converter including a transformer, a sensing resistor, and a first impedance element, wherein the transformer includes the primary winding, a secondary winding, and an auxiliary winding configured to generate an auxiliary voltage, the first switch is coupled to the transformer, the sensing resistor and the first switch are coupled together at a sensing node and the sensing resistor is configured to sense a current flowing through the first switch to generate a current sensing signal, and the first impedance element is coupled to the auxiliary winding; the primary-side control circuit comprising: a multifunctional pin coupled to the sensing node; an auxiliary signal sensing circuit configured, during an auxiliary signal sensing operation, to generate an auxiliary current collaboratively with the first impedance element through the multifunctional pin, and configured to receive the auxiliary current through the multifunctional pin to generate an auxiliary-related output signal; and a current sensing circuit configured, during a current sensing operation, to receive the current sensing signal through the multifunctional pin to generate a current-related output signal; wherein, during an on-period, the current sensing circuit is configured to perform the current sensing operation through the multifunctional pin, and during an off-period, the auxiliary signal sensing circuit is configured to perform the auxiliary signal sensing operation through the multifunctional pin; wherein the on-period corresponds to a conduction time of the first switch and the off-period corresponds to a non-conduction time of the first switch; and wherein, during the off-period, the auxiliary current flowing through the multifunctional pin is positively correlated with the auxiliary voltage, and the auxiliary voltage is positively correlated with a voltage across the secondary winding.

From another perspective, the present invention provides a control method for controlling a first switch of a flyback converter to switch a primary winding, the flyback converter including a transformer, a sensing resistor, a first impedance element, and a multifunctional pin; wherein the transformer includes a primary winding, a secondary winding, and an auxiliary winding configured to generate an auxiliary voltage, the first switch is coupled to the transformer, the sensing resistor and the first switch are coupled together at a sensing node and the sensing resistor is configured to sense a current flowing through the first switch to generate a current sensing signal, and the first impedance element is coupled to the auxiliary winding; the control method comprising: during an off-period, performing an auxiliary signal sensing operation through the multifunctional pin, wherein, during the auxiliary signal sensing operation, generating an auxiliary current collaboratively with the first impedance element through the multifunctional pin and receiving the auxiliary current through the multifunctional pin to generate an auxiliary-related output signal; and during an on-period, performing a current sensing operation through the multifunctional pin, wherein, during the current sensing operation, receiving the current sensing signal through the multifunctional pin to generate a current-related output signal; wherein the on-period corresponds to a conduction time of the first switch and the off-period corresponds to a non-conduction time of the first switch; and wherein, during the off-period, the auxiliary current flowing through the multifunctional pin is positively correlated with the auxiliary voltage, and the auxiliary voltage is positively correlated with a voltage across the secondary winding.

The present invention provides a flyback converter that performs current sensing function and the auxiliary voltage sensing function through a shared pin, which reduces the number of pins, size, and cost.

The objectives, technical details, features, and effects of the present invention will be better understood with regard to the detailed description of the embodiments below, with reference to the attached drawings.

### BRIEF DESCRIPTION OF THE DRAWINGS

FIG. 1 illustrates a flyback converter of the prior art.

FIG. 2 illustrates a circuit block diagram of a flyback converter according to one embodiment of the present invention.

FIGS. 3A and 3B illustrate circuit block diagrams of the primary-side control circuit of the flyback converter according to two embodiments of the present invention.

FIG. 4 illustrates an operation waveform diagram of a primary-side control circuit according to one embodiment of the present invention.

FIG. 5 illustrates a schematic diagram of an auxiliary signal sensing circuit of the primary-side control circuit according to one embodiment of the present invention.

FIG. 6 illustrates a circuit block diagram of an auxiliary signal sensing circuit of the primary-side control circuit according to one embodiment of the present invention.

FIG. 7A illustrates a schematic diagram of an auxiliary signal sensing circuit of the primary-side control circuit according to one specific embodiment of the present invention.

FIG. 7B illustrates a schematic diagram of an auxiliary signal sensing circuit of the primary-side control circuit according to one specific embodiment of the present invention.

FIG. 8 illustrates a schematic diagram of an auxiliary signal sensing circuit of the primary-side control circuit according to one specific embodiment of the present invention.

FIG. 9 illustrates a schematic diagram of an auxiliary signal sensing circuit of the primary-side control circuit according to one specific embodiment of the present invention.

FIG. 10 illustrates a schematic diagram of an auxiliary signal sensing circuit of the primary-side control circuit according to one specific embodiment of the present invention.

FIG. 11 illustrates a schematic diagram of a current sensing circuit of the primary-side control circuit according to one embodiment of the present invention.

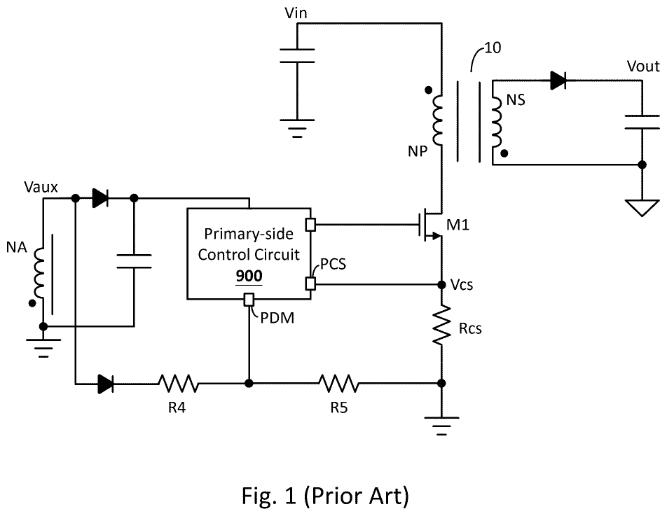

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

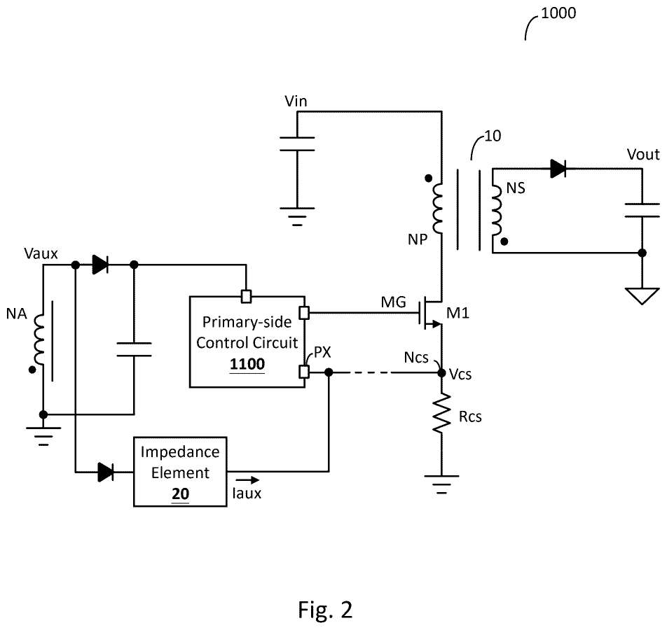

FIG. 2 illustrates a circuit block diagram of a flyback converter according to one embodiment of the present invention. In one embodiment, a flyback converter 1000 includes a transformer 10, a first switch M1, a sensing resistor Rcs, an impedance element 20, and a primary-side control circuit 1100. In one embodiment, the primary-side control circuit 1100 is configured to control the first switch M1 to switch electrical connections of the transformer 10, thereby converting an input voltage Vin into an output voltage Vout. In one embodiment, the transformer 10 includes the primary winding NP, a secondary winding NS, and an auxiliary winding NA, wherein the auxiliary winding NA is configured to generate an auxiliary voltage Vaux, and the auxiliary voltage Vaux is positively correlated with a voltage across the secondary winding NS. In one embodiment, the first switch M1 is coupled to the primary winding NP of the transformer 10. The sensing resistor Rcs and the first switch M1 are coupled together at a sensing node Ncs, and the sensing resistor Rcs is configured to sense a current flowing through the first switch M1 to generate a current sensing signal Vcs. The impedance element 20 is coupled to the auxiliary winding NA. In one embodiment, the primary-side control circuit 1100 is configured to control the first switch M1 to switch electrical connections of the primary winding NP. The primary-side control circuit 1100 includes a multifunctional pin PX, coupled to the sensing node Ncs, and in this embodiment, the multifunctional pin PX is further coupled to the impedance element 20.

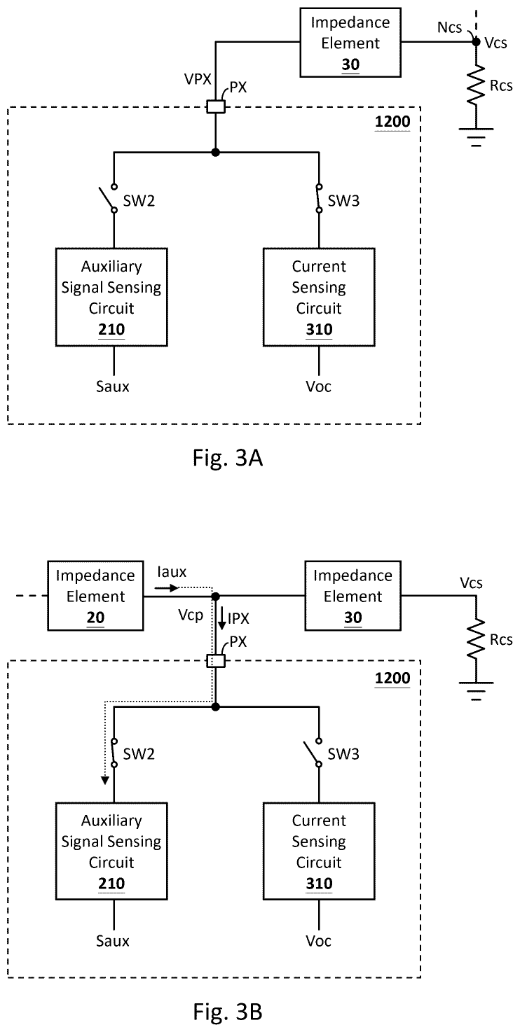

FIGS. 3A and 3B illustrate circuit block diagrams of the primary-side control circuit of the flyback converter according to two embodiments of the present invention. In one embodiment, as shown in FIG. 3A or FIG. 3B, the primary-side control circuit 1200 includes the multifunctional pin PX, a second switch SW2 and a third switch SW3, an auxiliary signal sensing circuit 210, and a current sensing circuit 310. In one embodiment, the flyback converter further includes an impedance element 30 coupled between the sensing node Ncs and the multifunctional pin PX. In one embodiment, as shown in FIG. 3A, during an on-period Ton in which the first switch M1 is conductive, the third switch SW3 is conductive and the second switch SW2 is non-conductive, and the current sensing circuit 310 is configured to perform a current sensing operation through the multifunctional pin PX. In another embodiment, as shown in FIG. 3B, during an off-period Toff in which the first switch M1 is non-conductive, the second switch SW2 is conductive and the third switch SW3 is non-conductive, the auxiliary signal sensing circuit 210 is configured to perform an auxiliary signal sensing operation through the multifunctional pin PX.

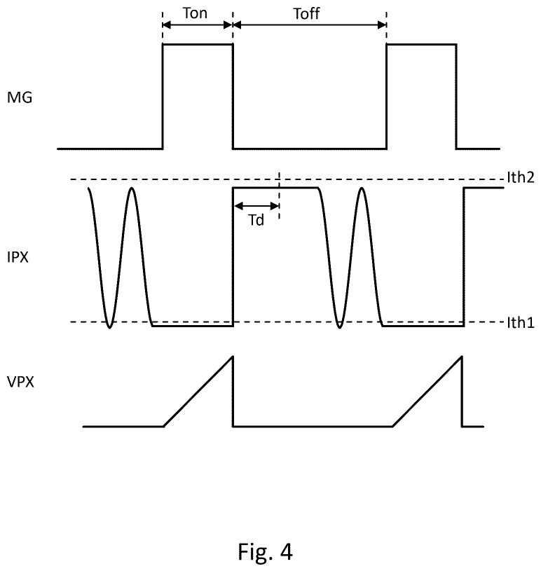

FIG. 4 illustrates an operation waveform diagram of a primary-side control circuit according to one embodiment of the present invention. In one embodiment, a control signal MG is configured to control a gate of the first switch M1. In one embodiment, as shown in FIG. 4, during an on-period Ton in which the control signal MG is at a high level, the first switch M1 is conductive, and during an off-period Toff in which the control signal MG is at a low level, the first switch M1 is non-conductive. It is to be noted that in the embodiments of the present invention described hereinafter, the current sensing operation is performed during the on-period Ton, and the auxiliary signal sensing operation is performed during the off-period Toff.

Referring simultaneously to FIGS. 3A, 3B, and 4, in one embodiment, as shown in FIG. 3A, the current sensing circuit 310 is configured, during the current sensing operation, to receive the current sensing signal Vcs through the multifunctional pin PX, so as to generate a current-related output signal Voc. In this embodiment, as shown in FIG. 4, during the on-period Ton, a voltage VPX at the multifunctional pin PX is positively correlated with the current sensing signal Vcs. In a preferred embodiment, no current flows through the multifunctional pin PX at this time. In other words, an input terminal, coupled to the multifunctional pin PX, of the current sensing circuit 310 has high-impedance.

In one embodiment, as shown in FIG. 3B, the auxiliary signal sensing circuit 210 is configured, during the auxiliary signal sensing operation, to generate an auxiliary current Iaux collaboratively with the impedance element 20 through the multifunctional pin PX, and to receive the auxiliary current Iaux through the multifunctional pin PX so as to generate an auxiliary-related output signal Saux. In this embodiment, as shown in FIG. 4, during the off-period Toff, a current IPX flowing through the multifunctional pin PX is positively correlated with the auxiliary voltage Vaux, and a voltage at the multifunctional pin PX is clamped to a clamp voltage Vcp. It is to be noted that in this embodiment, the clamp voltage Vcp is independent of the auxiliary voltage Vaux, i.e., the clamp voltage Vcp does not vary with variations of the auxiliary voltage Vaux. In a preferred embodiment, the current IPX is substantially equal to the auxiliary current Iaux. In other words, an impedance value of the impedance element 30 is much greater than an input impedance of the auxiliary signal sensing circuit 210. Accordingly, during the auxiliary signal sensing operation, the impedance element 30 is configured to isolate the auxiliary current Iaux such that the auxiliary current Iaux substantially flows through the multifunctional pin PX into the auxiliary signal sensing circuit (as indicated by the dashed current path in FIG. 3B).

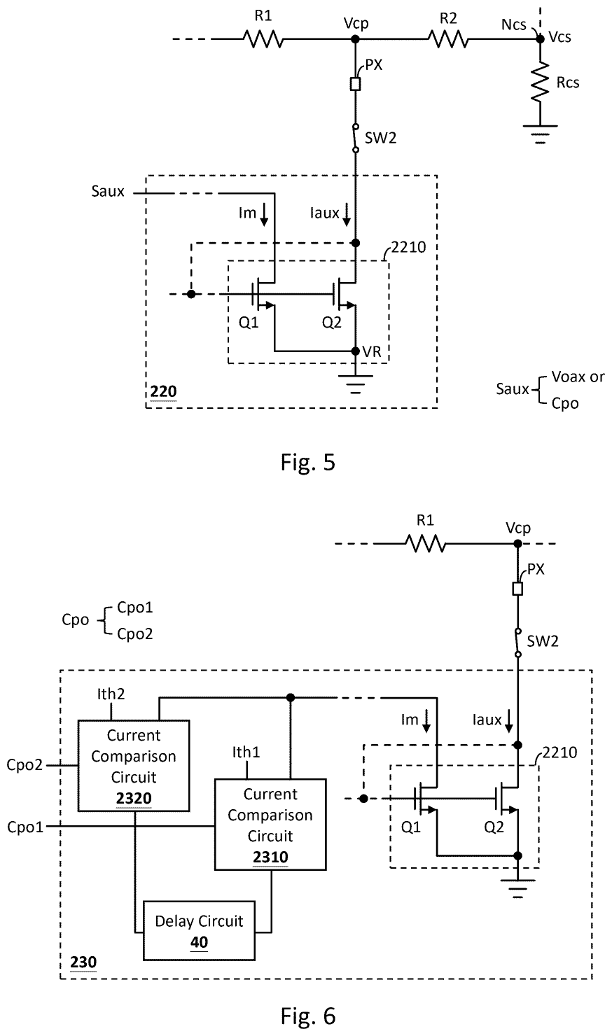

FIG. 5 illustrates a schematic diagram of an auxiliary signal sensing circuit of the primary-side control circuit according to one embodiment of the present invention. In one embodiment, the impedance element 20 is implemented as a resistor R1, and the impedance element 30 is implemented as a resistor R2. In one embodiment, an impedance value of the resistor R2 is much greater than an impedance value of the sensing resistor Rcs, such that an equivalent impedance value of the resistor R2 and the sensing resistor Rcs is much greater (e.g., at least 10 times or 100 times greater) than the input impedance of the auxiliary signal sensing circuit 210 described above. Accordingly, during the auxiliary signal sensing operation, the resistor R2 isolates the auxiliary current Iaux to prevent the auxiliary current Iaux from flowing through the sensing resistor Rcs.

In one embodiment, as shown in FIG. 5, an auxiliary signal sensing circuit 220 includes a current mirror circuit 2210. In one specific embodiment, the current mirror circuit 2210 includes a transistor Q1 and a transistor Q2, wherein the transistors Q1 and Q2 are, for example, NMOS transistors. In one embodiment, the transistors Q1 and Q2 are operated in a saturation region by feedback control, such that the clamp voltage Vcp is not linearly related to the auxiliary voltage Vaux. In this embodiment, the auxiliary signal sensing operation includes: generating the auxiliary current Iaux collaboratively with the resistor R1 through the multifunctional pin PX and receiving the auxiliary current Iaux so as to generate a mirrored current Imat a first terminal (e.g., a drain) of the transistor Q1 by a first terminal (e.g., a drain) of the transistor Q2, wherein the first terminal of the transistor Q2 is further configured, for example, through feedback, to control the clamp voltage Vcp. In this embodiment, a control terminal (e.g., a gate) of the transistor Q1 and a control terminal (e.g., a gate) of the transistor Q2 are coupled together, and a second terminal (e.g., a source) of the transistor Q1 and a second terminal (e.g., a source) of the transistor Q2 are jointly coupled to a reference voltage VR, wherein the reference voltage VR is, for example, a ground potential. The feedback control of the first terminal of the transistor Q2 can be implemented in various embodiments, which will be further described hereinafter.

In one embodiment, as shown in FIG. 5, the auxiliary signal sensing circuit 220 is configured to generate the auxiliary-related output signal Saux based on the mirrored current Im. In one embodiment, the auxiliary-related output signal Saux corresponds to an analog output signal Voax or a comparison output signal Cpo. In this embodiment, the analog output signal Voax is positively correlated with the auxiliary voltage Vaux. The comparison output signal Cpo indicates a comparison result between the mirrored current Im and a current comparison threshold. In one embodiment, optionally, the first switch M1 can be switched based on the auxiliary-related output signal Saux so as to perform, for example, zero voltage switching (ZVS) control of the first switch M1 and/or over-voltage protection (OVP) control, details of which will be further described hereinafter.

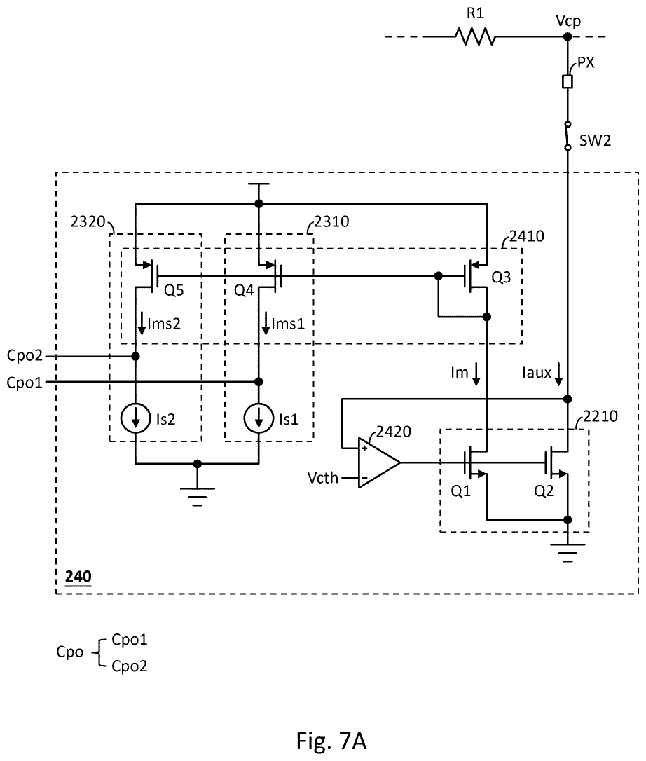

FIG. 6 illustrates a circuit block diagram of an auxiliary signal sensing circuit of the primary-side control circuit according to one embodiment of the present invention. In one embodiment, an auxiliary signal sensing circuit 230 further includes a current comparison circuit 2310 and/or a current comparison circuit 2320, and the current comparison threshold includes a first current comparison threshold Ith1 and/or a second current comparison threshold Ith2. In one embodiment, the auxiliary signal sensing operation includes: comparing the mirrored current Im with the first current comparison threshold Ith1 so as to generate a comparison output signal Cpo1 by the current comparison circuit 2310. In this embodiment, the first current comparison threshold Ith1 is associated with a valley voltage Vva of the auxiliary voltage Vaux. When the mirrored current Im is lower than the first current comparison threshold Ith1 (indicating that the auxiliary voltage Vaux reaches the valley voltage Vva), the comparison output signal Cpo1 is configured to control the first switch M1 to turn on, thereby achieving zero voltage switching of the first switch M1. In another embodiment, the auxiliary signal sensing operation includes: comparing the mirrored current Im with the second current comparison threshold Ith2 so as to generate a comparison output signal Cpo2 by the current comparison circuit 2320. In this embodiment, the second current comparison threshold Ith2 is associated with an over-voltage threshold of the auxiliary voltage Vaux. When the mirrored current Im is higher than the second current comparison threshold Ith2 (indicating that an output voltage Vout is higher than an over-voltage protection threshold), the comparison output signal Cpo2 is configured to control the first switch M1 to turn off, thereby achieving over-voltage protection of the output voltage Vout.

In one embodiment, as shown in FIG. 6, the auxiliary signal sensing circuit 230 further includes a delay circuit 40, configured to generate a delay time Td. In one embodiment, when the first switch M1 turns off to enter the off-period Toff, after the delay time Td elapses (as shown in FIG. 4), the current comparison circuits 2310 and 2320 begin the aforementioned operation of comparing the mirrored current Im with the current comparison thresholds.

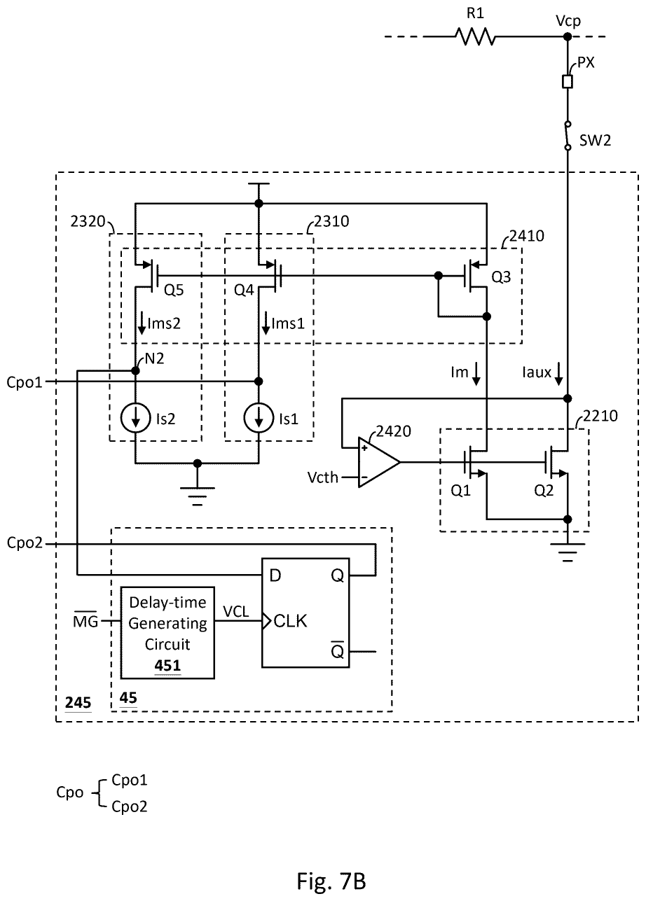

FIG. 7A illustrates a schematic diagram of an auxiliary signal sensing circuit of the primary-side control circuit according to one specific embodiment of the present invention. The auxiliary signal sensing circuit 240 of FIG. 7A is a specific embodiment of the auxiliary signal sensing circuit 230 of FIG. 6. In one embodiment, the auxiliary signal sensing circuit 240 further includes a current mirror circuit 2410 and an amplifier circuit 2420. In one specific embodiment, the current mirror circuit 2410 includes transistors Q3-Q5, the current comparison circuit 2310 includes the transistor Q4 and a current source Is1, and the current comparison circuit 2320 includes the transistor Q5 and a current source Is2. In this embodiment, the auxiliary signal sensing operation further includes: mirroring the mirrored current Im to generate a sub-mirrored current Ims1 and/or Ims2 by the current mirror circuit 2410. In one specific embodiment, current values of the current sources Is1 and Is2 respectively correspond to the first current comparison threshold Ith1 and the second current comparison threshold Ith2, thereby enabling the current comparison circuits 2310 and 2320 to perform the comparison operations described in FIG. 6, so as to generate the comparison output signals Cpo1 and/or Cpo2, respectively.

In one specific embodiment, as shown in FIG. 7A, the auxiliary signal sensing operation further includes: amplifying a voltage difference between a voltage at the first terminal (drain) of the transistor Q2 and a reference voltage Vcth, and to control terminals (gates) of the transistors Q1 and Q2 through feedback control by the amplifier circuit 2420, such that the first terminal (drain) of the transistor Q2 is clamped to the clamp voltage Vcp, thereby clamping the voltage at the multifunctional pin PX to the clamp voltage Vcp. In one embodiment, the clamp voltage is associated with the reference voltage Vcth. In the specific embodiment of FIG. 7A, the clamp voltage is equal to the reference voltage Vcth (e.g., 0.3V). Other operation details of FIG. 7A can be inferred by a person skilled in the art from the descriptions of the foregoing embodiments.

FIG. 7B illustrates a schematic diagram of an auxiliary signal sensing circuit of the primary-side control circuit according to one specific embodiment of the present invention. The auxiliary signal sensing circuit 245 of FIG. 7B is similar to the auxiliary signal sensing circuit 240 of FIG. 7A, and the differences are described below. In one embodiment, as shown in FIG. 7B, the auxiliary signal sensing circuit 245 further includes a delay circuit 45. In one specific embodiment, the delay circuit 45 includes a delay-time generating circuit 451 and a D-type flip-flop. In this embodiment, a node N2 between the transistor Q5 and the current source Is2 is coupled to a data input terminal D of the D-type flip-flop, and the delay-time generating circuit 451 is configured to generate a clock signal VCL based on a control signal MG (i.e., an inverted signal of the control signal M̅G̅ The clock signal VCL is coupled to a clock input terminal CLK of the D-type flip-flop, so as to generate the comparison output signal Cpo2 at a positive output terminal Q of the D-type flip-flop. In the embodiment of FIG. 7B, the current comparison circuit 2320 generates the comparison output signal Cpo2 after the delay time Td.

It is to be noted that the delay-time generating circuit 451 is configured to ensure that the clock signal VCL triggers the D-type flip-flop after the delay time Td following turn-off of the first switch M1, so as to avoid false triggering caused by signal noise during switching of the first switch M1. It is further to be noted that other operation details of FIG. 7B can be inferred from the foregoing embodiments, and the delay circuit 45 may also be implemented in other embodiments of the present invention.

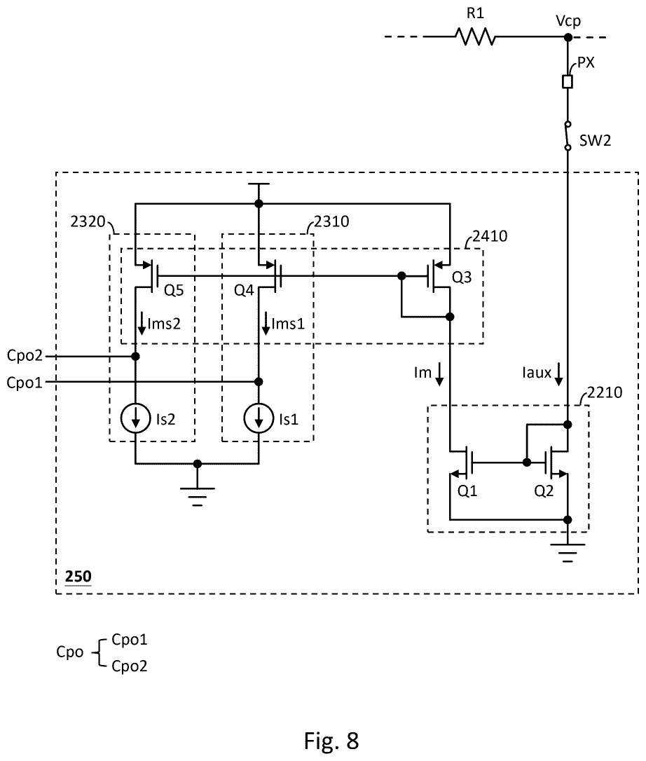

FIG. 8 illustrates a schematic diagram of an auxiliary signal sensing circuit of the primary-side control circuit according to one specific embodiment of the present invention. The auxiliary signal sensing circuit 250 of FIG. 8 is another specific embodiment of the auxiliary signal sensing circuit 230 of FIG. 6. In one specific embodiment, as shown in FIG. 8, the control terminal (gate) of the transistor Q2 is coupled to the first terminal (drain) of the transistor Q2 so as to configure the transistor Q2 as a diode-connected transistor. In one specific embodiment, the auxiliary signal sensing operation further includes: the control terminal (gate) of the transistor Q2 controls the transistor Q2, through feedback, based on the voltage at the first terminal (drain voltage) of the transistor Q2, thereby clamping the voltage at the first terminal to the clamp voltage Vcp. In this embodiment, the clamp voltage Vcp is associated with a threshold voltage of the transistor Q2, and specifically, the clamp voltage Vcp is, for example, 0.7V. Other operation details of FIG. 8 can be inferred by a person skilled in the art from the descriptions of the foregoing embodiments.

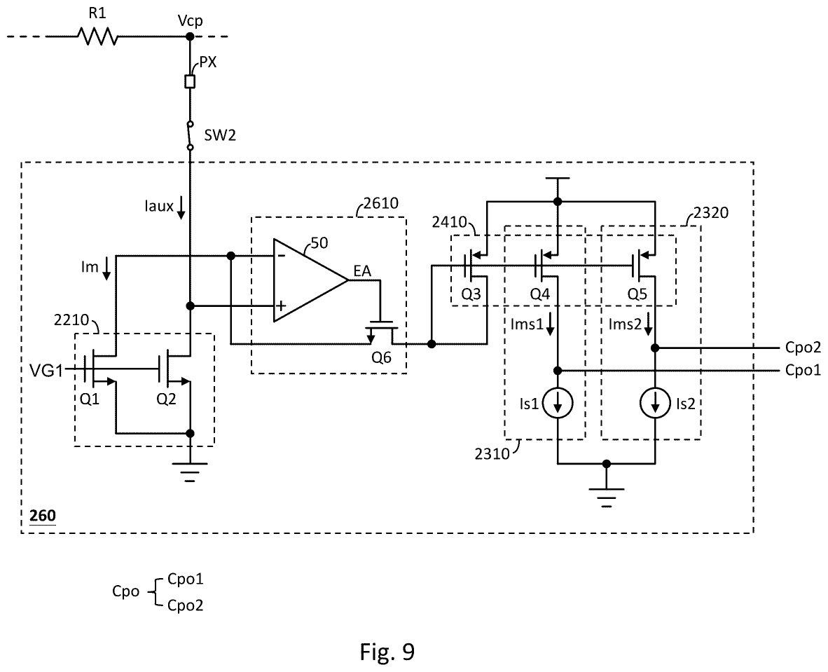

FIG. 9 illustrates a schematic diagram of an auxiliary signal sensing circuit of the primary-side control circuit according to one specific embodiment of the present invention. The auxiliary signal sensing circuit 260 of FIG. 9 is a specific embodiment of the auxiliary signal sensing circuit 230 of FIG. 6. In one embodiment, the auxiliary signal sensing circuit 260 further includes an amplifier circuit 2610. In one specific embodiment, as shown in FIG. 9, the auxiliary signal sensing operation further includes: controlling the voltage at the first terminal (drain voltage) of the transistor Q1 to track the voltage at the first terminal (drain voltage) of the transistor Q2 through negative feedback by the amplifier circuit 2610, such that a transistor current (drain-to-source current) flowing through the transistor Q1 is positively correlated with a transistor current (drain-to-source current) flowing through the transistor Q2. In this embodiment, the gates of the transistors Q1 and Q2 are coupled together to a control voltage VG1, the transistor current flowing through the transistor Q1 corresponds to the mirrored current Im, and the transistor current flowing through the transistor Q2 corresponds to the auxiliary current Iaux. In one embodiment, the transistors Q1 and Q2 operate in the saturation region, such that during the off-period Toff, the voltage at the multifunctional pin PX is clamped to the clamp voltage Vcp and is independent of the auxiliary voltage Vaux.

In one embodiment, as shown in FIG. 9, the amplifier circuit 2610 includes an error amplifier 50 and a transistor Q6, wherein the mirrored current Im flows through the transistors Q1, Q6, and Q3. The error amplifier 50 regulates its amplified output signal EA based on a voltage difference between the drain voltages of the transistors Q1 and Q2, so as to control a conduction level of the transistor Q6, thereby regulating the drain voltages of the transistors Q1 and Q2 to become substantially equal, such that the mirrored current Im and the auxiliary current Iaux have a linear proportional relationship (e.g., equal to each other). In the embodiment of FIG. 9, the current mirror circuit 2410 is configured to mirror the mirrored current Im to generate sub-mirrored currents Ims1 and Ims2. Other operation details of FIG. 9 can be inferred by a person skilled in the art from the descriptions of the foregoing embodiments.

It is to be noted that in the embodiments of FIGS. 7A, 7B, 8, and 9, the clamp voltage Vcp being independent of the auxiliary voltage Vaux refers to the clamp voltage Vcp being substantially independent of the auxiliary voltage Vaux. Specifically, the clamp voltage Vcp and the auxiliary voltage Vaux are not linearly related to each other, for example, at least not in a simple linear voltage-dividing relationship. It is further to be noted that since the auxiliary current Iaux is positively correlated with the auxiliary voltage Vaux and the clamp voltage Vcp is related to current-voltage characteristics of the transistor Q2, in some embodiments (e.g., the embodiments of FIGS. 8 and 9), the clamp voltage Vcp and the auxiliary voltage Vaux have a nonlinear relationship (e.g., a higher-order functional relationship).

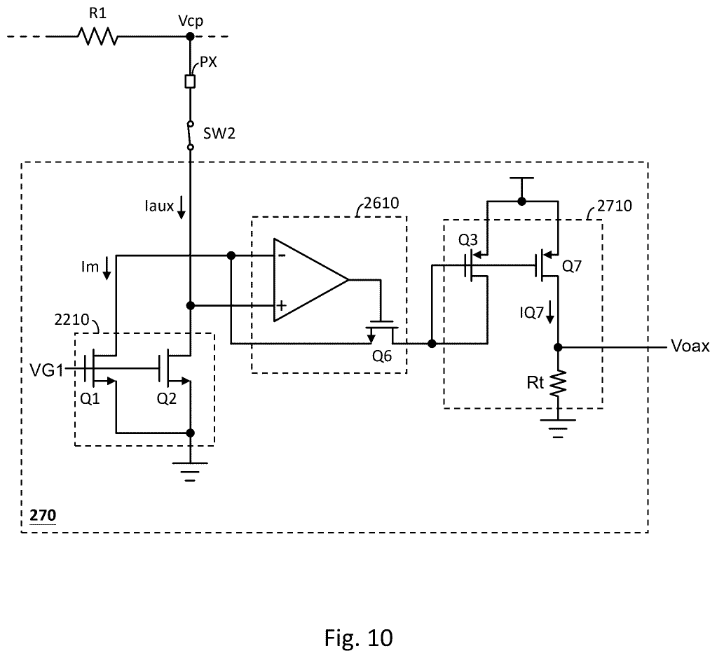

FIG. 10 illustrates a schematic diagram of an auxiliary signal sensing circuit of the primary-side control circuit according to one specific embodiment of the present invention. The auxiliary signal sensing circuit 270 of FIG. 10 is a specific embodiment corresponding to the auxiliary signal sensing circuit 220 of FIG. 5. In the embodiment of FIG. 10, the auxiliary-related output signal Saux corresponds to an analog output signal Voax. In one embodiment, the auxiliary signal sensing circuit 270 includes a current mirror circuit 2210, an amplifier circuit 2610, and a current-to-voltage conversion circuit 2710, wherein the current-to-voltage conversion circuit 2710 includes a conversion resistor Rt. In one specific embodiment, the auxiliary signal sensing operation further includes: mirroring the mirrored current Im to generate a transistor current IQ7 flowing through a transistor Q7 by the current-to-voltage conversion circuit 2710, and the conversion resistor Rt is configured to further generate the analog output signal Voax based on the transistor current IQ7. In this embodiment, the analog output signal Voax is positively correlated with the auxiliary voltage Vaux, and the primary-side control circuit is configured to control the output voltage Vout based on the analog output signal Voax.

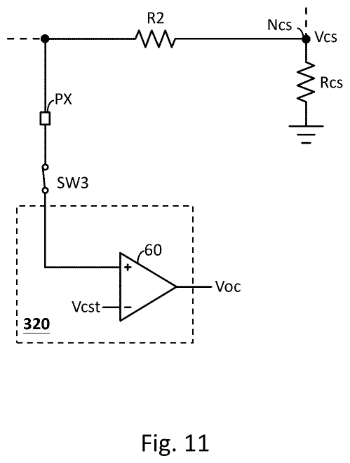

FIG. 11 illustrates a schematic diagram of a current sensing circuit of the primary-side control circuit according to one specific embodiment of the present invention. In one embodiment, the current sensing circuit 320 includes a current sensing comparator 60. In one specific embodiment, the current sensing operation includes: comparing the current sensing signal Vcs with a current sensing threshold Vcst to generate a current-related output signal Voc by the current sensing comparator 60. In this embodiment, when the current sensing signal Vcs exceeds the current sensing threshold Vcst, the current-related output signal Voc controls the first switch M1 to turn off, thereby achieving over-current protection (OCP) of the first switch M1.

Since the foregoing two sensing operations occur during different operating phases—the on-period Ton and the off-period Toff of the first switch M1—the present invention provides a flyback converter architecture that integrates execution of both the current sensing function and the auxiliary voltage sensing function through a single multifunctional pin PX, thereby effectively reducing the number of required pins. Specifically, during the on-period Ton, the multifunctional pin PX receives the current sensing signal Vcs from the sensing resistor Rcs to sense a current flowing through the first switch M1; and during the off-period Toff, the multifunctional pin PX generates the auxiliary current Iaux collaboratively with the auxiliary winding NA and the impedance element 20, and receives the auxiliary current to sense the auxiliary voltage Vaux corresponding to the output voltage Vout.

An advantage of the present invention is that, during the off-period Toff, the voltage at the multifunctional pin PX is clamped to the clamp voltage Vcp, and the clamp voltage Vcp is independent of the auxiliary voltage Vaux, i.e., the two are not linearly related. This feature enables the voltage received at the multifunctional pin PX to be unaffected by fluctuations of the auxiliary voltage Vaux, thereby allowing stable mirroring and comparison operations of the auxiliary current Iaux, and further improving sensing accuracy and stability of the primary-side control circuit. Through the aforementioned structural integration and voltage isolation design, the present invention not only effectively reduces the number of pins and the complexity of circuit routing, but also improves control reliability and integration efficiency of the flyback converter in applications such as zero voltage switching and over-voltage protection.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to (or based on)” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A flyback converter, comprising:
a transformer, including a primary winding, a secondary winding, and an auxiliary winding, wherein the auxiliary winding is configured to generate an auxiliary voltage;
a first switch, coupled to the transformer;
a sensing resistor, coupled to the first switch at a sensing node and configured to sense a current flowing through the first switch to generate a current sensing signal;
a first impedance element, coupled to the auxiliary winding; and
a primary-side control circuit, configured to control the first switch to switch the primary winding, wherein the primary-side control circuit includes:
a multifunctional pin, coupled to the sensing node;
an auxiliary signal sensing circuit configured, during an auxiliary signal sensing operation, to generate an auxiliary current collaboratively with the first impedance element through the multifunctional pin, and configured to receive the auxiliary current through the multifunctional pin to generate an auxiliary-related output signal; and
a current sensing circuit configured, during a current sensing operation, to receive the current sensing signal through the multifunctional pin to generate a current-related output signal;
wherein, during an on-period, the current sensing circuit is configured to perform the current sensing operation through the multifunctional pin, and during an off-period, the auxiliary signal sensing circuit is configured to perform the auxiliary signal sensing operation through the multifunctional pin;
wherein the on-period corresponds to a conduction time of the first switch, and the off-period corresponds to a non-conduction time of the first switch; and
wherein, during the off-period, the auxiliary current flowing through the multifunctional pin is positively correlated with the auxiliary voltage, and the auxiliary voltage is positively correlated with a voltage across the secondary winding.

2. The flyback converter of claim 1, wherein during the off-period, a voltage at the multifunctional pin is clamped to a clamp voltage, and the clamp voltage is independent of the auxiliary voltage.

3. The flyback converter of claim 2, wherein the auxiliary signal sensing circuit includes a current mirror circuit; wherein the auxiliary signal sensing operation includes:
generating a mirrored current based on the auxiliary current by the current mirror circuit; and
generating the auxiliary-related output signal based on the mirrored current by the auxiliary signal sensing circuit;
wherein the auxiliary-related output signal corresponds to an analog output signal or a comparison output signal, the analog output signal being positively correlated with the auxiliary voltage, and the comparison output signal indicating a comparison result between the mirrored current and a current comparison threshold;
wherein the auxiliary-related output signal is optionally configured to control the first switch.

4. The flyback converter of claim 3, wherein the auxiliary signal sensing circuit further includes a first current comparison circuit and/or a second current comparison circuit, the current comparison threshold including a first current comparison threshold and/or a second current comparison threshold; wherein the auxiliary signal sensing operation includes:
comparing the mirrored current with the first current comparison threshold by the first current comparison circuit, and controlling the first switch to turn on through the comparison output signal when the mirrored current is lower than the first current comparison threshold, wherein the first current comparison threshold is associated with a valley voltage of the auxiliary voltage; and/or
comparing the mirrored current with the second current comparison threshold by the second current comparison circuit, and controlling the first switch to turn off through the comparison output signal when the mirrored current is higher than the second current comparison threshold, wherein the second current comparison threshold is associated with an over-voltage threshold of the auxiliary voltage.

5. The flyback converter of claim 4, wherein, when the first switch turns off to enter the off-period, the first current comparison circuit and/or the second current comparison circuit begins operation after a delay time.

6. The flyback converter of claim 3, wherein the current mirror circuit includes a first transistor and a second transistor, and the first impedance element includes a resistor; wherein the auxiliary signal sensing operation includes:
generating the auxiliary current collaboratively with the resistor through the multifunctional pin and receiving the auxiliary current by a first terminal of the second transistor, thereby generating the mirrored current at a first terminal of the first transistor, and controlling the clamp voltage by the first terminal of the second transistor;
wherein a second terminal of the first transistor and a second terminal of the second transistor are jointly coupled to a first reference voltage, and a control terminal of the first transistor and a control terminal of the second transistor are coupled together.

7. The flyback converter of claim 6, wherein the auxiliary signal sensing circuit further includes a first amplifier circuit; wherein the auxiliary signal sensing operation further includes:
controlling the first transistor and the second transistor based on a voltage at the first terminal of the second transistor and a second reference voltage through feedback by the first amplifier circuit, such that the voltage at the first terminal of the second transistor is clamped to the clamp voltage, wherein the clamp voltage is associated with the second reference voltage.

8. The flyback converter of claim 6, wherein the control terminal of the second transistor is coupled to the first terminal of the second transistor to form a diode-connected transistor; wherein the auxiliary signal sensing operation further includes:
controlling the control terminal of the second transistor based on a voltage at the first terminal of the second transistor through feedback, thereby clamping the voltage at the first terminal to the clamp voltage, wherein the clamp voltage is associated with a threshold voltage of the second transistor.

9. The flyback converter of claim 6, wherein the auxiliary signal sensing circuit further includes a second amplifier circuit; wherein the auxiliary signal sensing operation further includes:
controlling a voltage at the first terminal of the first transistor to track a voltage at the first terminal of the second transistor through feedback by the second amplifier circuit, such that a first transistor current flowing through the first transistor is positively correlated with a second transistor current flowing through the second transistor;
wherein the first transistor current corresponds to the mirrored current;
wherein the first transistor and the second transistor operate in a saturation region, such that during the off-period, the voltage at the multifunctional pin is clamped to the clamp voltage and is independent of the auxiliary voltage.

10. The flyback converter of claim 3, wherein the auxiliary signal sensing circuit further includes a conversion resistor; wherein the auxiliary signal sensing operation further includes:
generating the analog output signal based on the mirrored current by the conversion resistor.

11. The flyback converter of claim 6, wherein the first transistor and the second transistor operate in a saturation region such that the clamp voltage is not linearly related to the auxiliary voltage.

12. The flyback converter of claim 1, wherein the current sensing circuit includes a current sensing comparator; wherein the current sensing operation includes: comparing the current sensing signal with a current sensing threshold to generate the current-related output signal by the current sensing comparator, wherein the current-related output signal controls the first switch to turn off when the current sensing signal exceeds the current sensing threshold.

13. The flyback converter of claim 1, further comprising: a second impedance element coupled between the sensing node and the multifunctional pin, and configured to isolate the auxiliary current during the auxiliary signal sensing operation, such that the auxiliary current flows through the multifunctional pin into the auxiliary signal sensing circuit.

14. The flyback converter of claim 13, wherein an impedance value of the second impedance element is greater than an impedance value of the sensing resistor for at least 100 times.

15. A primary-side control circuit configured to control a first switch of a flyback converter to switch a primary winding, the flyback converter including a transformer, a sensing resistor, and a first impedance element, wherein the transformer includes the primary winding, a secondary winding, and an auxiliary winding configured to generate an auxiliary voltage, the first switch is coupled to the transformer, the sensing resistor and the first switch are coupled together at a sensing node and the sensing resistor is configured to sense a current flowing through the first switch to generate a current sensing signal, and the first impedance element is coupled to the auxiliary winding; the primary-side control circuit comprising:
a multifunctional pin, coupled to the sensing node;
an auxiliary signal sensing circuit configured, during an auxiliary signal sensing operation, to generate an auxiliary current collaboratively with the first impedance element through the multifunctional pin, and configured to receive the auxiliary current through the multifunctional pin to generate an auxiliary-related output signal; and
a current sensing circuit configured, during a current sensing operation, to receive the current sensing signal through the multifunctional pin to generate a current-related output signal;
wherein, during an on-period, the current sensing circuit is configured to perform the current sensing operation through the multifunctional pin, and during an off-period, the auxiliary signal sensing circuit is configured to perform the auxiliary signal sensing operation through the multifunctional pin;
wherein the on-period corresponds to a conduction time of the first switch and the off-period corresponds to a non-conduction time of the first switch; and
wherein, during the off-period, the auxiliary current flowing through the multifunctional pin is positively correlated with the auxiliary voltage, and the auxiliary voltage is positively correlated with a voltage across the secondary winding.

16. The primary-side control circuit of claim 15, wherein during the off-period, a voltage at the multifunctional pin is clamped to a clamp voltage, and the clamp voltage is independent of the auxiliary voltage.

17. The primary-side control circuit of claim 16, wherein the auxiliary signal sensing circuit includes a current mirror circuit; wherein the auxiliary signal sensing operation includes:
generating a mirrored current based on the auxiliary current by the current mirror circuit; and
generating the auxiliary-related output signal based on the mirrored current by the auxiliary signal sensing circuit;
wherein the auxiliary-related output signal corresponds to an analog output signal or a comparison output signal, the analog output signal being positively correlated with the auxiliary voltage, and the comparison output signal indicating a comparison result between the mirrored current and a current comparison threshold; and
wherein the auxiliary-related output signal is optionally configured to control the first switch.

18. The primary-side control circuit of claim 17, wherein the auxiliary signal sensing circuit further includes a first current comparison circuit and/or a second current comparison circuit, the current comparison threshold including a first current comparison threshold and/or a second current comparison threshold; wherein the auxiliary signal sensing operation includes:
comparing the mirrored current with the first current comparison threshold by the first current comparison circuit, and controlling the first switch to turn on through the comparison output signal when the mirrored current is lower than the first current comparison threshold, wherein the first current comparison threshold is associated with a valley voltage of the auxiliary voltage; and/or
comparing the mirrored current with the second current comparison threshold by the second current comparison circuit, and controlling the first switch to turn off through the comparison output signal when the mirrored current is higher than the second current comparison threshold, wherein the second current comparison threshold is associated with an over-voltage threshold of the auxiliary voltage;
wherein, when the first switch turns off to enter the off-period, the first current comparison circuit and/or the second current comparison circuit begins operation after a delay time.

19. The primary-side control circuit of claim 17, wherein the current mirror circuit includes a first transistor and a second transistor, and the first impedance element includes a resistor; wherein the auxiliary signal sensing operation includes:
generating the auxiliary current collaboratively with the resistor through the multifunctional pin and receiving the auxiliary current by a first terminal of the second transistor, thereby generating the mirrored current at a first terminal of the first transistor, and controlling the clamp voltage by the first terminal of the second transistor; and
wherein a second terminal of the first transistor and a second terminal of the second transistor are jointly coupled to a first reference voltage, and a control terminal of the first transistor and a control terminal of the second transistor are coupled together.

20. The primary-side control circuit of claim 19, wherein the auxiliary signal sensing circuit further includes a first amplifier circuit; wherein the auxiliary signal sensing operation further includes:
controlling the first transistor and the second transistor based on a voltage at the first terminal of the second transistor and a second reference voltage through feedback by the first amplifier circuit, such that the voltage at the first terminal of the second transistor is clamped to the clamp voltage, wherein the clamp voltage is associated with the second reference voltage.

21. The primary-side control circuit of claim 19, wherein the control terminal of the second transistor is coupled to the first terminal of the second transistor to form a diode-connected transistor; wherein the auxiliary signal sensing operation further includes:
controlling the control terminal of the second transistor based on a voltage at the first terminal of the second transistor through feedback, thereby clamping the voltage at the first terminal to the clamp voltage, wherein the clamp voltage is associated with a threshold voltage of the second transistor.

22. The primary-side control circuit of claim 19, wherein the auxiliary signal sensing circuit further includes a second amplifier circuit; wherein the auxiliary signal sensing operation further includes:
controlling a voltage at the first terminal of the first transistor to track a voltage at the first terminal of the second transistor through feedback by the second amplifier circuit, such that a first transistor current flowing through the first transistor is positively correlated with a second transistor current flowing through the second transistor;
wherein the first transistor current corresponds to the mirrored current;
wherein the first transistor and the second transistor operate in a saturation region, such that during the off-period, the voltage at the multifunctional pin is clamped to the clamp voltage and is independent of the auxiliary voltage.

23. The primary-side control circuit of claim 17, wherein the auxiliary signal sensing circuit further includes a conversion resistor; wherein the auxiliary signal sensing operation further includes:
generating the analog output signal based on the mirrored current by the conversion resistor.

24. The primary-side control circuit of claim 19, wherein the first transistor and the second transistor operate in a saturation region such that the clamp voltage is not linearly related to the auxiliary voltage.

25. The primary-side control circuit of claim 15, wherein the current sensing circuit includes a current sensing comparator; wherein the current sensing operation includes:
comparing the current sensing signal with a current sensing threshold to generate the current-related output signal by the current sensing comparator, wherein the current-related output signal controls the first switch to turn off when the current sensing signal exceeds the current sensing threshold.

26. The primary-side control circuit of claim 15, wherein the flyback converter further comprises: a second impedance element coupled between the sensing node and the multifunctional pin, and configured to isolate the auxiliary current during the auxiliary signal sensing operation, such that the auxiliary current flows through the multifunctional pin into the auxiliary signal sensing circuit.

27. The primary-side control circuit of claim 26, wherein an impedance value of the second impedance element is greater than an impedance value of the sensing resistor for at least 100 times.

28. A control method for controlling a first switch of a flyback converter to switch a primary winding, the flyback converter including a transformer, a sensing resistor, a first impedance element, and a multifunctional pin; wherein the transformer includes a primary winding, a secondary winding, and an auxiliary winding configured to generate an auxiliary voltage, the first switch is coupled to the transformer, the sensing resistor and the first switch are coupled together at a sensing node and the sensing resistor is configured to sense a current flowing through the first switch to generate a current sensing signal, and the first impedance element is coupled to the auxiliary winding; the control method comprising:
during an off-period, performing an auxiliary signal sensing operation through the multifunctional pin, wherein, during the auxiliary signal sensing operation, generating an auxiliary current collaboratively with the first impedance element through the multifunctional pin and receiving the auxiliary current through the multifunctional pin to generate an auxiliary-related output signal; and
during an on-period, performing a current sensing operation through the multifunctional pin, wherein, during the current sensing operation, receiving the current sensing signal through the multifunctional pin to generate a current-related output signal;
wherein the on-period corresponds to a conduction time of the first switch and the off-period corresponds to a non-conduction time of the first switch; and
wherein, during the off-period, the auxiliary current flowing through the multifunctional pin is positively correlated with the auxiliary voltage, and the auxiliary voltage is positively correlated with a voltage across the secondary winding.

29. The control method of claim 28, wherein the step of performing the auxiliary signal sensing operation further includes: during the off-period, clamping a voltage at the multifunctional pin to a clamp voltage, wherein the clamp voltage is independent of the auxiliary voltage.

30. The control method of claim 29, wherein the step of performing the auxiliary signal sensing operation further includes: generating an auxiliary-related output signal based on the auxiliary current; and optionally controlling the first switch by the auxiliary-related output signal;
wherein the auxiliary-related output signal corresponds to an analog output signal or a comparison output signal, the analog output signal being positively correlated with the auxiliary voltage, and the comparison output signal indicating a comparison result between the auxiliary current and a current comparison threshold°.
